(19) United States
(12) Patent Application Publication
(10) Pub. No.: US 2001/0004141 A1
(43) Pub. Date: Jun. 21, 2001

(54) Hydraulic vibration isolator

(76) Inventors: Yoshiki Shimoda, Aichi-ken (JP); Naoki Mori, Aichi-ken (JP); Kouji Nakamura, Toyota-shi (JP)

Correspondence Address: Pillsbury Madison & Sutro LLP, Intellectual Property Group, Ninth Floor, East Tower, 1100 New York Avenue, N.W., Washington, DC, 20005-3918, US

(21) Appl. No.: 09/732,908

(22) Filed: Dec. 11, 2000

(30) Foreign Application Priority Data
Dec. 10, 1999 (JP) 11-350959

(51) Int. Cl. F16F 9/00; F16M 5/00

(52) U.S. Cl. 267/140.13

(57) ABSTRACT

A vibration isolator includes an upper coupling member to be mounted on a vibrating body, a cup-shaped holder to be mounted on a car body, and a rubber-like insulator which is located between the upper coupling member and the cup-shaped holder to isolate vibrations from the vibrating body. The vibration isolator further includes a main chamber and a subchamber, which are arranged in series with the insulator and in which a liquid, an incompressive fluid, is enclosed, an annular orifice interconnecting the main chamber and the subchamber, a partition member dividing the main chamber and the subchamber, a diaphragm which is made of a rubber membrane-like member and defines a part of the subchamber, and an air chamber formed below the diaphragm. Both the partition member and the diaphragm are entirely formed of rubber-like elastic bodies. This provides a large area for the central flexible portion of the partition member, reducing the manufacturing costs of the parts including the diaphragm.

### BACKGROUND OF THE INVENTION

The present invention relates to a hydraulic vibration isolator that produces a vibration isolating effect, based on the flowing action of an incompressive fluid or liquid enclosed inside. More particularly, it relates to a hydraulic vibration isolator that uses a rubber-like elastic body for forming an entire partition member that partially define parts of a main chamber and a subchamber where the liquid is enclosed and that contributes to the formation of an annular orifice connecting the two liquid chambers.

Vibration isolators, especially automotive engine mounts and the like, must accommodate a wide rage of frequencies because the engine or power source is used under various conditions ranging from idling to maximum engine speed conditions. In view of this, a so-called liquid-sealed or hydraulic type engine mount or vibration isolator that has two liquid chambers connected by an orifice has been devised and is known publicly. To isolate high-frequency vibrations, i.e., vibrations associated with booming engine noise and the like, some hydraulic vibration isolators use a flexible member, which is formed of a rubber membrane-like elastic body, in the center of the rigid member dividing the main chamber and the subchamber. The rubber membrane-like flexible member function to absorb the increase in liquid pressure caused by vibrations in a relatively high-frequency range of 100 Hz to 600 Hz to lower the dynamic spring constant of the entire vibration isolators.

The conventional hydraulic vibration isolators described above have an orifice interconnecting the main chamber and the subchamber, which is formed annularly in the outer peripheral portion of a rigid partition member. In this annular orifice, the above described rubber membrane-like flexible member is disposed concentrically with this annular ring. Thus, the area of the rubber membrane-like flexible member is inevitably limited and cannot be large. Consequently, the rubber membrane-like flexible member or rubber membrane provided has a small diameter in comparison to the volume of the main chamber (liquid chamber), and there is a fear that it will fail to absorb the liquid pressure of the main chamber sufficiently. Besides, the rigid partition member is made mainly of an aluminum alloy or the like and the rubber membrane-like flexible member is attached to its center by vulcanization bonding or the like. Therefore, this partition member has the problem that it entails high manufacturing costs.

### BRIEF SUMMARY OF THE INVENTION

An object of the present invention is to solve the above problem by providing a hydraulic vibration isolator that can secure a sufficiently large area presented to the pressure for the rubber membrane or flexible member and reduce manufacturing costs.

To attain the above object, the invention takes the following measures. Specifically, according to the invention as set forth in claim 1, a hydraulic vibration isolator comprises a first coupling member to be mounted on a vibrating body, a second coupling member to be mounted on a car body, a rubber-like insulator located between the two coupling members for absorbing and isolating vibrations from the vibrating body, a main chamber and a subchamber provided in series with the insulator, in which a liquid, an incompressive fluid, is enclosed, an orifice connecting the main chamber and the subchamber, a partition member dividing the main chamber and the subchamber, and a rubber membrane-like diaphragm defining a part of the subchamber. Further, the partition member consists entirely of a rubber-like elastic body and is held with its outer peripheral portion being clamped vertically between the peripheral portions of the rubber-like insulator and the rubber diaphragm.

With this construction, the apparatus according to the invention can provide an ample space for the rubber membrane-like flexible portion at the bottom of the main chamber and thus reduce the rise in the liquid pressure of the main chamber caused by the high-frequency components of vibration inputs. Consequently, it has achieved a low dynamic spring constant with respect to the high-frequency vibrations associated with booming noise, thereby isolating the booming noise and the like.

Also, as set forth in claim 2, the partition member and the diaphragm are preferably made entirely of rubber-like elastic bodies. More specifically, the apparatus according to claim 1 further employs the construction in which the portion supporting the peripheral portion of the partition member in the peripheral portion of the rubber diaphragm, which partially defines the subchamber, consists entirely of a rubber-like elastic body. According to this construction, the apparatus of the invention has all the components made of the rubber-like elastic bodies, including the diaphragm that contributes to forming the subchamber and the annular orifice in addition to the partition member. This reduces the manufacturing costs of the entire apparatus.

### BRIEF DESCRIPTION OF THE SEVERAL VIEWS OF THE DRAWINGS

The foregoing and other objects, features and advantages of the invention will become more apparent from the description of embodiments of the invention which will be made with reference to the accompanying drawings, in which:

FIG. 1 is a longitudinal section showing the general construction of a vibration isolator according to an embodiment of the invention;

FIG. 2 is a developed view showing individual parts of the apparatus shown in FIG. 1; and

FIG. 3 is a longitudinal section showing the general construction of a modification of the apparatus shown in FIG. 1.

### DETAILED DESCRIPTION OF THE INVENTION

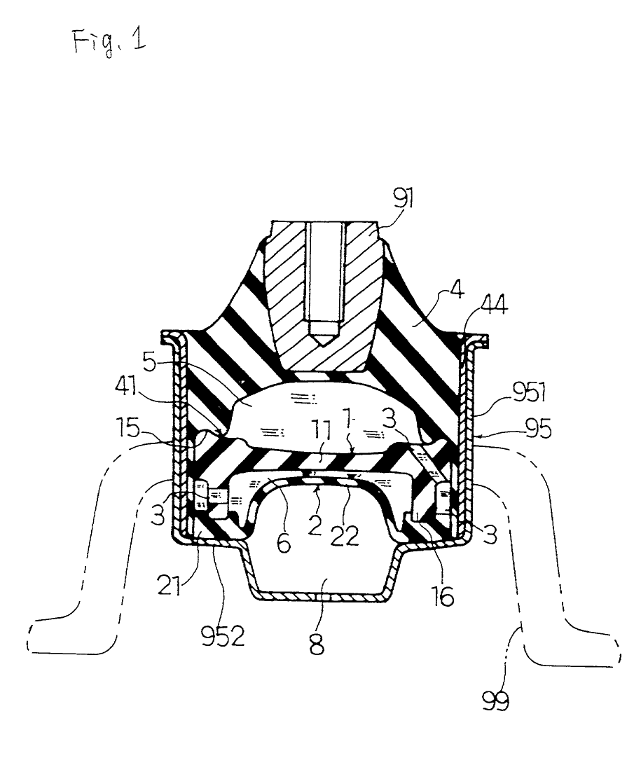

The embodiments of the invention will be described with reference to FIGS. 1 to 3. The vibration isolator according to the embodiment shown in FIG. 1 is essentially comprised of an upper coupling member 91 to be mounted on a vibrating body, which constitutes a first coupling member, a cup-shaped holder 95 to be mounted on a car body, which constitutes a second coupling member, and a rubber-like insulator 4 which is located between the upper coupling member 91 and the cup-shaped holder 95 to isolate vibrations from the vibrating body.

The apparatus further comprises a main chamber 5 and a subchamber 6 arranged in series with the insulator 4, in which a liquid, an incompressive fluid, is enclosed, an annular orifice 3 connecting the main chamber 5 and the subchamber 6, a partition member 1 dividing the main chamber 5 and the subchamber 6, a diaphragm 2 which is made of a rubber membrane-like member and partially defines the subchamber 6, and an air chamber 8 formed under the diaphragm 2.

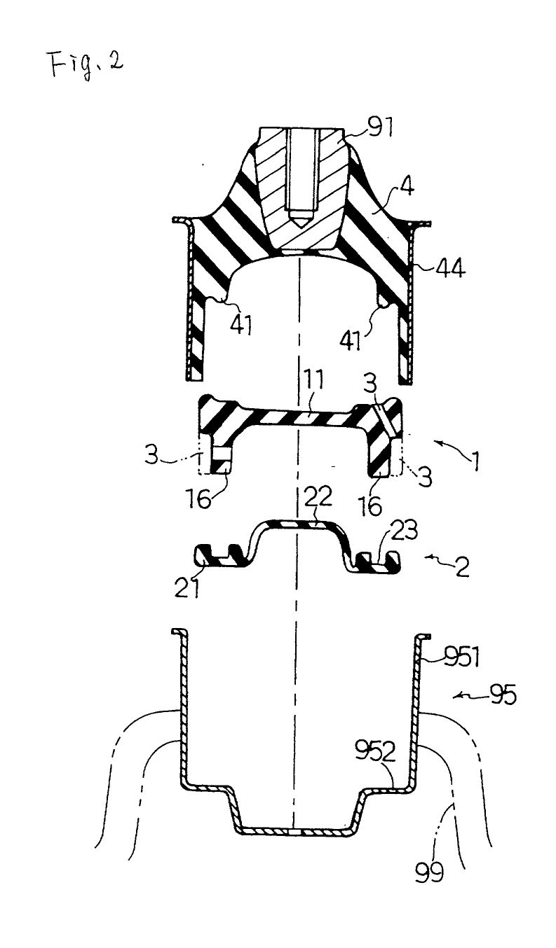

The partition member 1 is in a disk-like shape and is made entirely of a rubber-like elastic body. This disk-like body has an annular groove provided in its outer peripheral portion. The annular groove is formed over approximately half the circumference of the disk-like partition member 1. The annular groove constitutes the orifice 3 which interconnects the main chamber 5 and the subchamber 6. See FIG. 2.

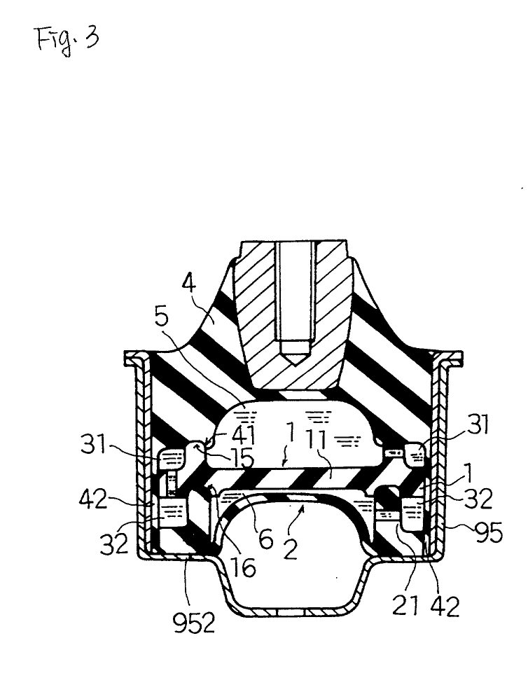

Instead of the annular orifice shown in FIGS. 1 and 2, annular orifices may be provided in both upper and lower surfaces of the partition member 1 as shown in a modification of FIG. 3. This construction the length of the orifice 3 to be prolonged so as to adequately adjust the vibration isolating characteristics of the hydraulic vibration isolator.

Specifically, the orifice 3 according to the modification is comprised of an upper orifice 31 and a lower orifice 32 as shown in FIG. 3. The upper orifice 31 is defined between a sealing portion 41 formed on the lower edge of the insulator 4 and a main-chamber-side sealing portion 15 formed on the outer peripheral portion of the partition member 1. The lower orifice 32 is defined by the underside of the outer peripheral portion of the partition member 1, a peripheral sealing portion 21 of the diaphragm 2, and a skirt 42 of the insulator 4.

In the apparatuses according to the embodiment and its modification described above, it is essential that the sealing portion 41 on the insulator 4 side, the main-chamber-side sealing portion 15 of the partition member 1, a subchamber-side sealing portion 16 of the partition member 1, and the peripheral sealing portion 21 of the diaphragm 2 are in intimate contact to each other and are assembled in one body so as to transmit the force or load inputted from the sealing portion 41 of the insulator 4 to a bottom 952 of the holder 95.

A central flexible portion 11, which takes the form of a thin, flexible film, is formed in the center of the disk-like body. This central flexible portion 11 constitutes the bottom of the main chamber 5 as shown in FIGS. 1 and 3. The central flexible portion 11 deforms in response to vibration inputs in the high frequency region to suppress the rise in liquid pressure in the main chamber 5.

The main-chamber-side sealing portion 15 is provided annularly at an outer peripheral portion of the disk-like partition member 1 constructed as above, which comes into contact with the wall-like sealing portion 41 at the lower end of the rubber-like insulator 4. The sealing portion 15 keeps the main chamber 5 liquid-tight in cooperation with the sealing portion 41 on the side of the insulator 4. The protruding annular sealing portion 16 on the subchamber side is provided at an outer peripheral portion of the disk-like partition member 1, which is in contact with the peripheral portion of the diaphragm 2. The sealing portion 16 keeps the subchamber 6 liquid-tight in cooperation with the diaphragm 2 and forms a part of the side wall of the annular orifice 3. These parts are molded integrally from rubber-like material to form the rubber-like elastic partition member 1.

According to the modification shown in FIG. 3, the subchamber-side sealing portion 16 is formed on the side of the diaphragm 2.

The diaphragm 2 is disposed under the partition member 1 and defines the subchamber 6 in cooperation with the partition member 1. The diaphragm 2 is mainly for providing a thin-membrane or film portion 22 in the center. In this embodiment, the thick peripheral sealing portion 21, which is in contact with the partition member 1 and around the circumference of the thin-film portion 22, is also made entirely of a rubber-like elastic body. It is conventional to insert a metal reinforcement this peripheral sealing portion. The present embodiment, however, eliminates such a metal reinforcement and forms the peripheral sealing portion 21 solely from a thick portion of rubber-like material. This elimination of the metal reinforcement reduces the manufacturing costs of the diaphragm 2.

An annular sealing groove 23 is provided around the peripheral sealing portion 21, which is adapted to engage with the protruding subchamber-side sealing portion 16 provided on the partition member 1. The subchamber-side sealing portion 16 of the partition member 1 engages with this sealing groove 23, thereby keeping the subchamber 6 liquid-tight. The engaging portion of the subchamber-side sealing portion 16 and the sealing groove 23 as well as that of the main-chamber-side sealing portion 15 and the insulator-side sealing portion 41 may be of any form as long as one of the mating parts has a protrusion and the other has a recess.

Now the procedure for assembling the partition member 1 and the diaphragm 2 having the construction described above into the insulator 4, the holder 95, etc. will be described with reference to FIG. 2.

First, an appropriate liquid is prepared in a container or the like, and in this liquid, the rubber-like insulator 4, the rubber-like elastic partition member 1, and the rubber-like elastic diaphragm 2 are assembled into one body. That is, these three components are subassembled to form a liquid-sealed type vibration isolating section. Incidentally, the insulator 4 has already been fitted integrally with the upper coupling member 91 and an outer casing 44.

Then, this subassembly is installed into the cup-shaped holder 95. More particularly, the outer casing 44 of the subassembly is press-fitted into a cylindrical portion 951 of the cup-shaped holder 95. This brings the peripheral sealing portion 21 of the diaphragm 2 and the underside of the sealing groove 23 into contact with the bottom 952 of the cup-shaped holder 95 to hold the sealing groove 23 of the diaphragm 2 and the subchamber-side sealing portion 16 of the partition member 1 in intimate contact with each other. Also, the main-chamber-side sealing portion 15 of the partition member 1 and the sealing portion 41 of the insulator 4 are brought into intimate contact with each other. In this way, the insulator 4, the partition member 1 and the diaphragm 2 liquid-tightly from the main chamber 5 and the subchamber 6 to complete the hydraulic vibration isolator. The upper coupling member 91 of the hydraulic vibration isolator is connected to the engine side, while the cup-shaped holder 95 is connected to members on the car body side through external brackets 99.

The apparatus thus constructed has the following effects. The rubber membrane-like central flexible portion 11 covers a wide area at the bottom of the main chamber 5, effectively reducing the rise in the liquid pressure of the main chamber caused by the high-frequency components of vibration inputs. This results in a low dynamic spring constant with respect to the high-frequency vibrations in the range of 100 Hz to 600 Hz that would cause booming noise, making it possible to absorb and isolate the booming noise and the like. The wide area of the central flexible portion improves the durability of the portion made of rubber membrane or the central flexible portion 11.

In addition, according to this embodiment, the partition member 1 and the diaphragm 2 are all made of the rubber-like elastic bodies. This reduces the manufacturing costs of the partition member 1 and the diaphragm 2 that contributes to forming the annular orifice 3 as well as to the formation of the subchamber.

As described above, the invention, by adopting the construction set forth in claim 1, can provide the rubber membrane-like flexible portion of a large area at the bottom of the main chamber to reduce the rise in the liquid pressure of the main chamber caused by the high-frequency components of vibration inputs. Consequently, it has achieved a low dynamic spring constant with respect to the high-frequency vibrations associated with booming noise, making it possible to absorb and isolate the booming noise and the like effectively.

The partition member and the diaphragm are preferably made entirely of rubber-like elastic bodies. This reduces the manufacturing costs of the partition member and the diaphragm that contributes to the formation of the annular orifice as well as to the formation of the subchamber, consequently reducing the manufacturing cost of the entire hydraulic vibration isolator.

What is claimed is:

1. A hydraulic vibration isolator, comprising:
a first coupling member to be mounted on a vibrating body;
a second coupling member to be mounted on a car body;
a rubber-like insulator located between said coupling members for absorbing and isolating vibrations from the vibrating body;
a main chamber and a subchamber disposed in series with said insulator, said main chamber and said subchamber having a liquid of incompressive fluid enclosed therein;
an orifice interconnecting said main chamber and said subchamber;
a partition member dividing said main chamber and said subchamber;
a rubber membrane-like diaphragm defining a part of said subchamber; and
said partition member being entirely formed of a rubber-like elastic body and held with an outer peripheral portion thereof clamped vertically between peripheral portions of said rubber-like insulator and said rubber membrane-like diaphragm.

2. The hydraulic vibration isolator according to claim 1, wherein the portion at the periphery of said rubber membrane-like diaphragm defining the part of said subchamber, which portion holds the peripheral portion of said partition member, is entirely formed of a rubber-like elastic body.

3. The hydraulic vibration isolator according to claim 1, wherein said partition member has at a center area thereof a membrane-like flexible portion.

4. The hydraulic vibration isolator according to claim 1, wherein said insulator, said partition member and said diaphragm are engaged with one another through fitting of protrusions and recesses respectively formed on the peripheral portions of said insulator, said partition member and said diaphragm.

5. The hydraulic vibration isolator according to claim 4, wherein said insulator has a skirt portion suspending therefrom, and said office has a flow passage defined by said partition member, said diaphragm and said skirt portion of said insulator.

6. The hydraulic vibration isolator according to claim 1, wherein said orifice includes an annular orifice portion around an engaging portion between said partition member and said diaphragm.

7. The hydraulic vibration isolator according to claim 6, wherein said insulator has a skirt portion suspending therefrom, and said office has flow passage walls formed by said partition member, said diaphragm and said skirt portion of said insulator.

8. The hydraulic vibration isolator according to claim 1, wherein said orifice includes a first annular orifice groove disposed above said partition member and a second annular orifice groove disposed below said partition member.

9. The hydraulic vibration isolator according to claim 8, wherein said first orifice groove is formed around an engaging portion between said partition member and said insulator.

10. The hydraulic vibration isolator according to claim 8, wherein said second orifice groove is formed around an engaging portion between said partition member and said diaphragm.

11. The hydraulic vibration isolator according to claim 10, wherein said insulator has a skirt portion suspending therefrom, and said office has flow passage walls formed by said partition member, said diaphragm and said skirt portion of said insulator.
